(19) United States
(12) Patent Application Publication
(10) Pub. No.: US 2026/0082130 A1
(43) Pub. Date: Mar. 19, 2026

(54) IN-FIELD ACTUATOR CALIBRATION FOR IMAGING DEVICES WITH AUTOFOCUS AND/OR OPTICAL IMAGE STABILIZATION

(71) Applicant: Meta Platforms Technologies, LLC, Menlo Park, CA (US)

(72) Inventors: Shaomin Xiong, Newark, CA (US); Lidu Huang, Danville, CA (US); Qiulin Xie, San Jose, CA (US); Velko Todorov, Sofia (BG); Wenbin Wang, San Diego, CA (US); Michael Andrew Brookmire, Redwood City, CA (US); Hod Finkelstein, Oakland, CA (US); Yi Zhou, San Jose, CA (US); Yizhi Xiong, Foster City, CA (US); Honghong Peng, Los Altos, CA (US); Zhaochun Yu, Wilmette, IL (US); Likai Li, Cupertino, CA (US); Alan Kleiman Shwarsctein, Saratoga, CA (US); Te Hu, San Jose, CA (US); Ilya Brailovskiy, Fremont, CA (US); Xiaoxing Li, Los Gatos, CA (US); Shan Tong, Sunnyvale, CA (US); Sofus Stampe Mortensen, Zug (CH); Siarhei Koval, Zürich (CH); Bilal Demir, Zürich (CH)

(21) Appl. No.: 19/331,241

(22) Filed: Sep. 17, 2025

Related U.S. Application Data
(60) Provisional application No. 63/695,573, filed on Sep. 17, 2024.

(51) Int. Cl. H04N 23/68; G03B 13/36; H04N 25/705

(52) U.S. Cl. CPC H04N 23/687; G03B 13/36; H04N 25/705

(57) ABSTRACT

Systems and method for calibrating an imaging device are disclosed. A method is performed by a system including a processor communicatively coupled with an imaging device including an imaging-device element, an actuator coupled with the imaging-device element, and a digital-to-analog converter (DAC). The actuator is associated with predefined calibration data that causes the imaging device to achieve a performance characteristic. The method includes, in accordance with a determination that imaging-device recalibration criteria are satisfied, causing the DAC to provide the actuator a plurality of drive signals. Each drive signal of the plurality of drive signals causes the actuator to apply a respective force on the imaging-device element. The method includes obtaining displacement data corresponding to changes to the performance characteristic of the imaging device, generating recalibration data based on the displacement data, and associating the actuator with the recalibration data such that the imaging device achieves the performance characteristic.

### RELATED APPLICATION

This application claims priority to U.S. Provisional Application Ser. No. 63/695,573, filed Sep. 17, 2024, entitled “In-Field Calibration For Cameras With Autofocus And Optical Image Stabilization Actuators,” which is incorporated herein by reference.

### TECHNICAL FIELD

This relates generally to in-field actuator calibration of imaging devices and, more specifically, in-field calibration of autofocus and/or optical image stabilization enabled imaging devices.

### BACKGROUND

Performance of cameras including autofocus and optical image stabilization can degrade over time. In particular, performance of actuators and lenses of cameras can degrade over time, especially when exposed to harsh environments. Additionally, actuator degradation can be due to system control algorithms that use factory defined calibration data stored in the actuator driver. Degradation of actuators can be more pronounced based on the type of actuators used. Actuators experiencing degradation and/or drift due to various factors result in subpar performance and potentially negative impacts on photographic image quality. Currently, there are established procedures for recalibrating cameras in-field (after they are manufactured) to account for performance degradation.

As such, there is a need to address one or more of the above-identified challenges. A brief summary of solutions to the issues noted above are described below.

### SUMMARY

The systems and method disclosed herein provide a solution for the challenges that may arise when imaging devices and/or actuators are designed without the capability for recalibration after manufacture. The systems and method disclosed herein can restore imaging device and/or actuator performance through one or more in-field calibration processes. Non-limiting examples of the in-field calibration processes include autofocus actuator recalibration, optical image stabilization actuator recalibration, autofocus camera lens focal length recalibration, and tunable lens focal length recalibration.

One example of system for recalibrating an imaging device (or components thereof) is described herein. An example system includes one or more processors communicatively coupled with an imaging device including an imaging-device element, an actuator coupled with, at least, the imaging-device element, and a digital-to-analog converter (DAC). The actuator is associated with predefined calibration data that causes the imaging device to achieve a performance characteristic. The system further includes memory including executable instructions that, when executed by the one or more processors, cause the one or more processors to perform, in accordance with a determination that imaging-device recalibration criteria are satisfied, causing the DAC to provide the actuator a plurality of drive signals including, at least, drive signals with a predetermined starting value to a predetermined ending value Each drive signal of the plurality of drive signals causes the actuator to apply a respective force on the imaging-device element. The instructions, when executed by the one or more processors, further cause the one or more processors to perform obtaining displacement data corresponding to changes to the performance characteristic of the imaging device; generating recalibration data, distinct from the predefined calibration data, based, in part, on the displacement data; and associating the actuator with the recalibration data such that the imaging device achieves the performance characteristic.

An example method of recalibrating an imaging device (or components thereof) is described herein. The example method includes, in accordance with a determination that imaging-device recalibration criteria are satisfied, causing a DAC to provide an actuator a plurality of drive signals including, at least, drive signals with a predetermined starting value to a predetermined ending value Each drive signal of the plurality of drive signals causes the actuator to apply a respective force on the imaging-device element. The actuator is associated with predefined calibration data that causes the imaging device to achieve a performance characteristic. The method also includes obtaining displacement data corresponding to changes to the performance characteristic of the imaging device; generating recalibration data, distinct from the predefined calibration data, based, in part, on the displacement data; and associating the actuator with the recalibration data such that the imaging device achieves the performance characteristic.

An example non-transitory computer readable storage medium including instructions for recalibrating an imaging device (or components thereof) is described herein. The example non-transitory computer readable storage medium including instructions that, when executed by a computing device in communication with an imaging device, cause the computing device to perform, in accordance with a determination that imaging-device recalibration criteria are satisfied, causing the DAC to provide the actuator a plurality of drive signals including, at least, drive signals with a predetermined starting value to a predetermined ending value Each drive signal of the plurality of drive signals causes the actuator to apply a respective force on the imaging-device element. The actuator is associated with predefined calibration data that causes the imaging device to achieve a performance characteristic. The instructions, when executed by the computing device, further cause the one or more processors to perform obtaining displacement data corresponding to changes to the performance characteristic of the imaging device; generating recalibration data, distinct from the predefined calibration data, based, in part, on the displacement data; and associating the actuator with the recalibration data such that the imaging device achieves the performance characteristic.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates example imaging device performance based on actuator deviation and/or degradation, in accordance with some embodiments.

FIG. 2 illustrates example changes to performance of a lens included in an imaging device, in accordance with some embodiments

FIG. 3 illustrates example recalibration of an autofocus actuator, in accordance with some embodiments.

FIG. 4 illustrates example recalibration of an optical image stabilization actuator, in accordance with some embodiments.

FIG. 5 illustrates recalibration of an autofocus imaging device lens focal length, in accordance with some embodiments.

FIG. 6 illustrates recalibration of a tunable lens autofocus lens focal length, in accordance with some embodiments.

FIG. 7 illustrates an example system, in accordance with some embodiments.

FIG. 8 illustrates a flow diagram of a method of calibrating performance of an imaging device, in accordance with some embodiments.

FIGS. 9A, 9B, 9C-1, and 9C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

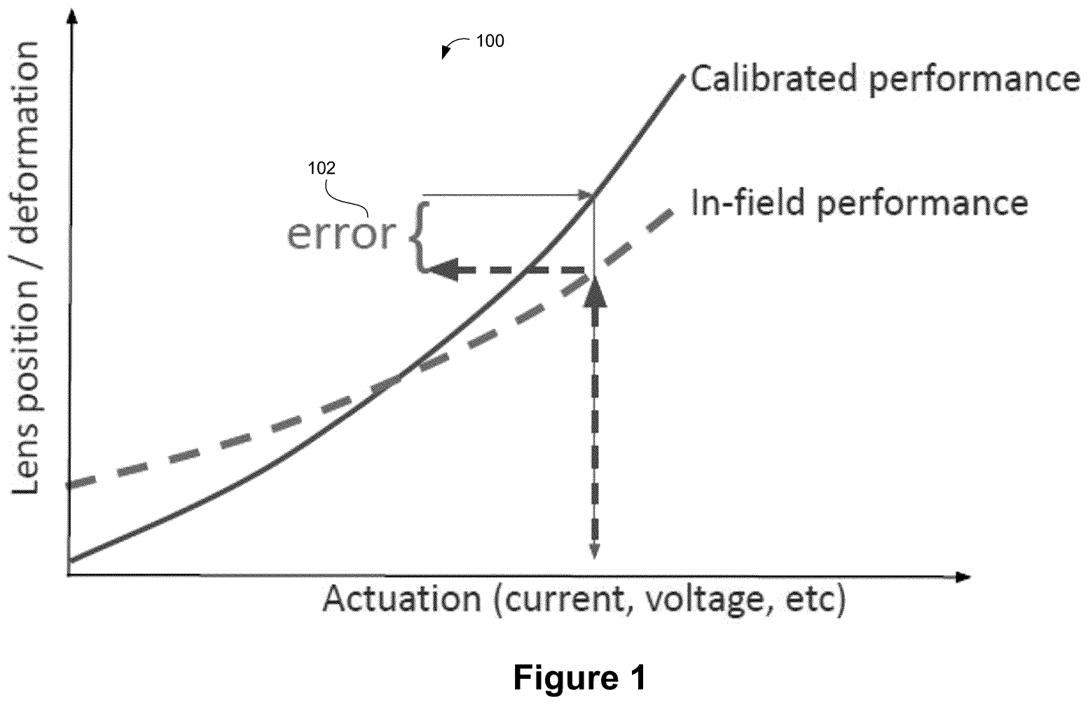

FIG. 1 illustrates example imaging device performance based on actuator deviation and/or degradation, in accordance with some embodiments. In some embodiments, as discussed below, actuator performance deviation and/or degradation can result in differences between calibrated performance and in-field performance of an imaging device (e.g., a camera). The performance of imaging devices and other actuator-based optical systems including autofocus and/or optical image stabilization (OIS) may degrade and/or deviate over time, particularly when exposed to harsh environmental conditions. Example degraded and/or deviated performance of an imaging device is represented in imaging device performance plot 100. In imaging device performance plot 100, the x-axis represents actuations of an actuator coupled with an imaging device element (e.g., a lens or image sensor) of an imaging device and the y-axis represents a position of the imaging device element based on a particular actuation. As described in detail below, the actuation of the actuator is based on one or more drive signals, provided by a digital-to-analog converter (DAC).

The imaging device performance plot 100 shows example predefined calibrated performance (denoted by a solid line) of the imaging device and example in-field performance (denoted by a broken line) of the imaging device. The predefined calibrated performance is defined during manufacture of the imaging device and the in-field performance is the (actual) performance experienced by a user of the imaging device (e.g., after wear and tear, drops, exposure to different environmental conditions, etc.). As shown by imaging device performance plot 100, differences between the predefined calibrated performance and the in-field performance of the imaging device can result in an error 102. For example, error 102 represents a difference between a predefined calibrated lens position of the imaging device and a degraded and/or deviated lens position of the imaging device for particular actuation.

In some embodiments, degradation and/or deviations of actuator performance and/or imaging device performance is caused by system control algorithms stored in an actuator driver. The system control algorithms can be based on (predefined) calibrated actuator behavior data, and are used to govern an imaging device actuator. The system control algorithms (and/or the (predefined) calibrated actuator behavior data) may not be updated to take into account degradation and/or drift of an actuator over time (due to various factors), which results in subpar performance and/or potentially negative impacts image quality.

Actuator degradation and/or drift over time can be due to one or more factors. For example, actuator performance deviation and/or degradation can be caused by a deformation of a voice coil motor (VCM) spring (e.g., caused by a shock or a drop); spring attaching adhesive re-location, changes to geometry and/or properties, position sensor errors due to degradation and a relative position change between moving and stationary components, changes to damping gel properties, demagnetization of the magnets and hall sensor, and/or other factors. Additionally, or alternatively, in some embodiments, actuator performance deviation and/or degradation is caused by deformed or shifted ball bearing structures, changes to lubricant properties, VCM magnet strength reduction and/or thermal drift, piezoelectric actuator performance degradation due to accumulated residual polarization, hysteresis, electric field actuation history, variations in lens polymer optical properties and/or thermal drift, changes to epoxy properties, and/or other factors. In some embodiments, actuator performance degradation and/or deviation may be more pronounced in some types of VCM actuators, piezoelectric actuators, and shape memory alloy (SMA) actuators. Actuator performance degradation and/or deviation can also occur in micro-electro-mechanical systems (MEMS) electrostatic actuators and/or other actuators.

As described herein, example systems and methods may include and/or use VCM actuators, piezoelectric actuators, shape memory alloy (SMA) actuators, MEMS electrostatic actuators, and/or other actuators. In some embodiments, the actuators disclosure herein may have various principles of operation, including springs, ball bearings, shaft-guide, shaft-rod, magnets, and piezoelectric elements. Alternatively, or in addition, in some embodiments, the systems and methods disclosed herein include actuated tunable lens. As such, the systems and methods disclosed herein perform one or more recalibration operations in accordance with a determination that recalibration criteria are satisfied. Non-limiting examples of recalibration criteria include out-of-specification conditions (e.g., autofocusing times, performance drift, etc.), predetermined time thresholds (e.g., one week, one month, six months, a year, etc.), a predetermined number of operations (e.g., 100, 500, 1,000, 10,000, etc. uses of an imaging device), and/or user requests (e.g. manually initiated recalibration process). For example, the systems and methods disclosed herein may initiate an actuator recalibration process in response to unacceptable delays in autofocusing times or anticipated degradation and performance drift over time.

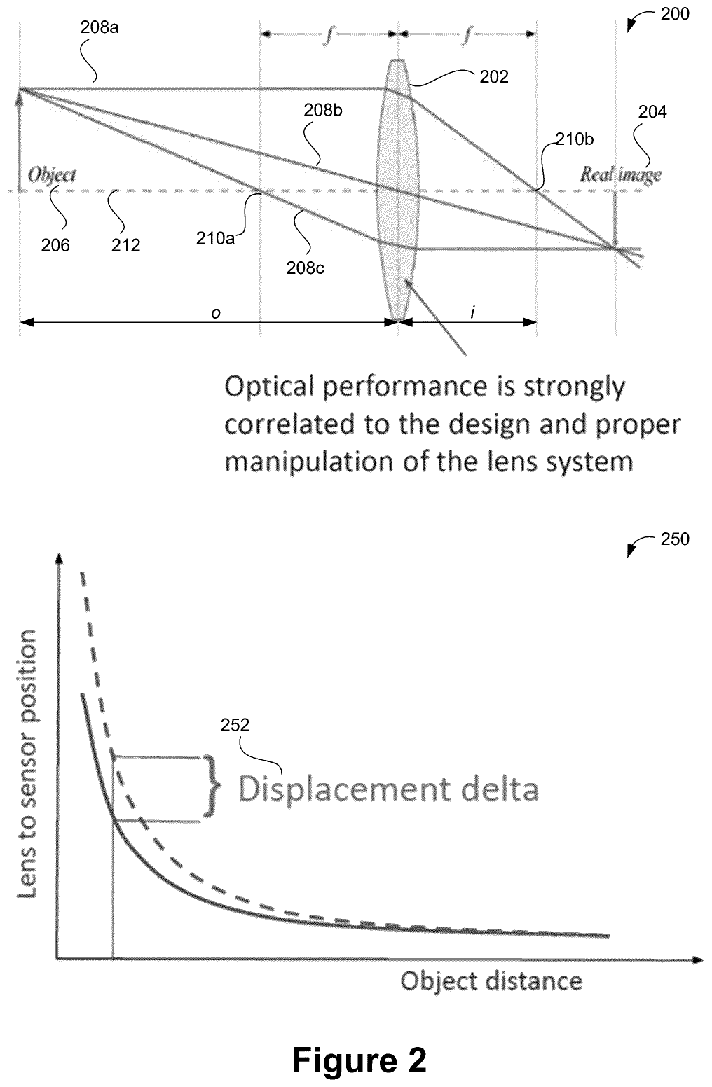

FIG. 2 illustrates example changes to performance of a lens included in an imaging device, in accordance with some embodiments. Image formation overview 200 shows example operation of thin (converging) lenses. In particular, the image formation overview 200 shows an image 204 formed by a lens 202 based on an object 206 (e.g., tip of the arrow). Ray tracing, as shown in image formation overview 200, is a method for determining how the lens 202 forms images by tracing the paths of light rays of an object. Ray tracing can use three rules for determining a size and a location of the image 204. For a converging lens, the three ray-tracing rules can include i) light rays entering a converging lens (e.g., lens 202) parallel to an optical axis pass through a focal point on the other side of the lens, ii) the light rays passing through the center of the lens are not deviated, and ii) the light rays that pass through the focal point exit the lens parallel to the optical axis.

The image formation overview 200 illustrates the three ray-tracing rules. For example, for the object 206, a first light ray 208a enters the converging lens (e.g., lens 202) parallel to an optical axis 212 and passes through a second focal point 210b on the other side of the lens 202, a second light ray 208b passes through the center of the lens 202 and is not deviated, and a third light rays 208c passes through a first focal point 210a exit the lens 202 parallel to the optical axis 212. In this example, the first and second focal points 210a and 210b have the same focal length. While the above example uses three light rays to locate image 204, less than three light rays can be used. A convergence point of the light rays 208 on the opposite side of the lens 202 represents a location of the image 204 (e.g., image of the tip of the arrow). Ray tracing can also be used to determine an orientation of the image 204.

In addition to ray tracing, the thin-lens equation can be used to relate the object 206's distance from the lens 202, the image 204's distance from the lens 202, and the lens 202's focal length (f) using the following formula:

$$\frac{1}{o} + \frac{1}{i} = \frac{1}{f} ; \qquad ( 1 )$$

$$i = \frac{of}{o - f} ; or \qquad ( 2 )$$

$$f = \frac{oi}{o + i} \qquad ( 3 )$$

where f represents a focal length, o represents a distance between the object and the lens, and i represents a distance between the image and the lens.

The thin-lens equation can be used to estimate image properties such as size, orientation, and/or whether the image is real or virtual.

A lens of an imaging device may sustain permanent damage, such as shifts to lens gaps, changes to lens material optical properties (e.g., optical refractive index change, etc.), and/or altered lens curvatures. Permanent damage to the lens results in a deviation between a lens to sensor position and object distance. For example, lens performance plot 250, which represents a lens to sensor position (y-axis) as a function of object distance (x-axis) and, shows a displacement delta 252 between a calibrated curve (represented by a solid line) and a displaced curve (represented by a broken line). In some embodiments, when the lens is permanently damaged, the displacement delta is present.

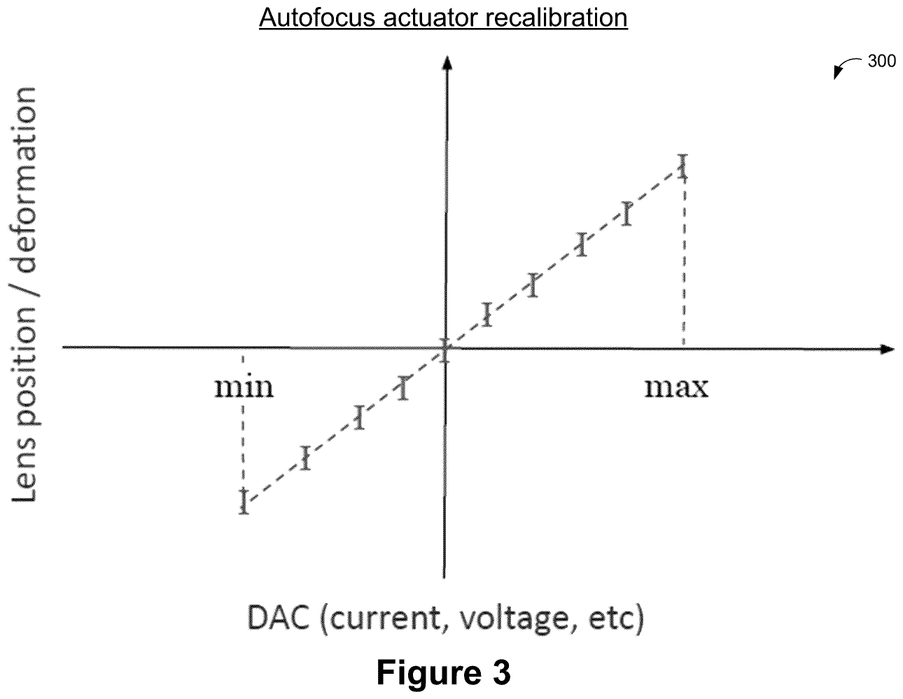

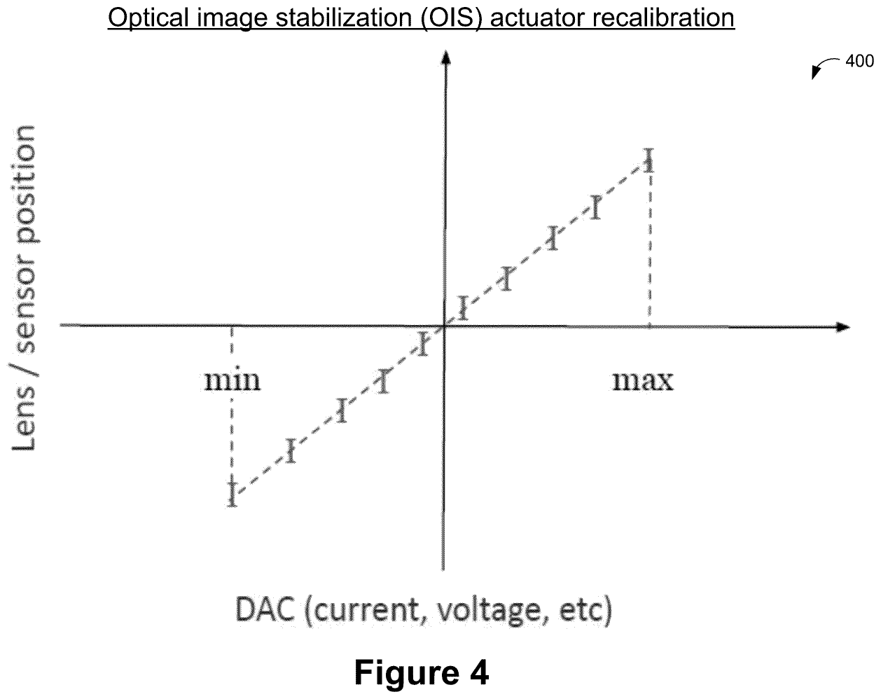

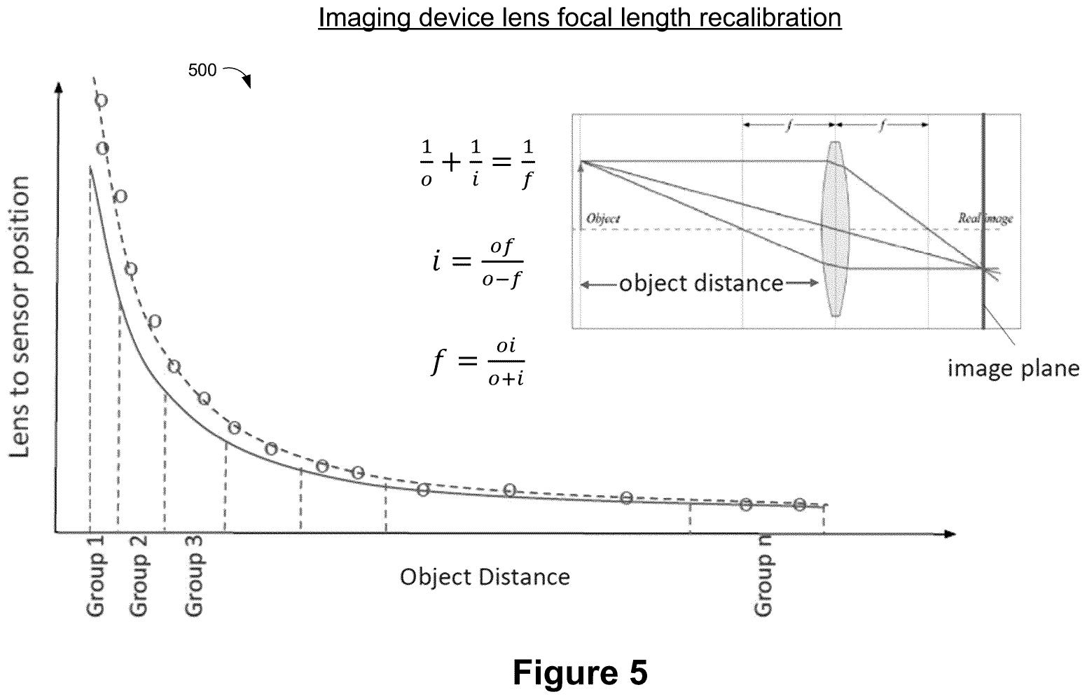

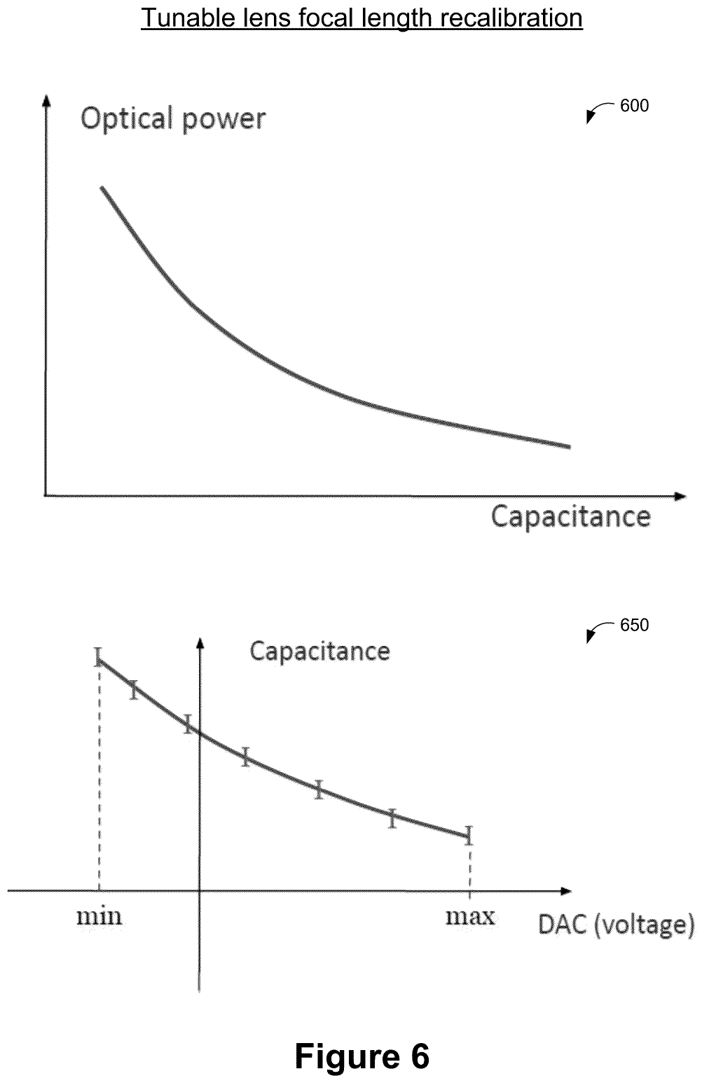

In some embodiments, actuator recalibration processes alone cannot enhance and/or improve autofocus precision when the lens sustains permanent damage. To account for permanent damage sustained by the lens, the systems and methods disclosed herein include a lens recalibration process, which recalibrates a focal length curve of the lens. In some embodiments, the systems and methods disclosed herein can perform the actuator recalibration processes, lens recalibration process, or both. As descried in detail below, FIG. 3 provides an example recalibration process for an autofocus actuator, FIG. 4 provides an example recalibration process for an OIS actuator, FIG. 5 provides an example recalibration process for an autofocus imaging device lens focal length, and FIG. 6 provides an example recalibration process for a tunable lens autofocus lens focal length.

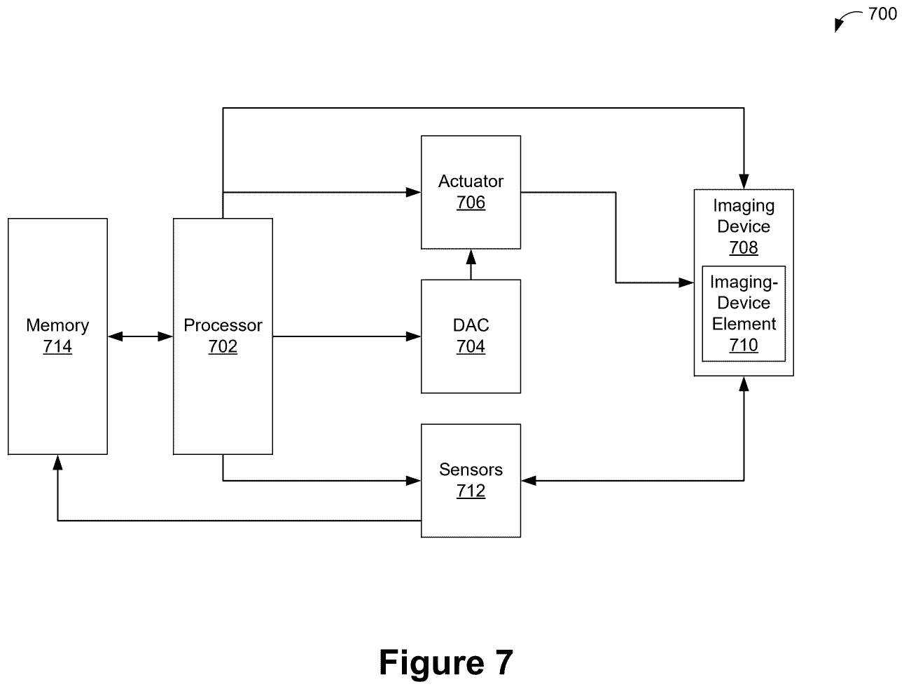

FIG. 3 illustrates example recalibration of an autofocus actuator, in accordance with some embodiments. The example recalibration process for the autofocus actuator can be performed by a system 700 including one or more processors 702 communicatively coupled with an actuator 706, an imaging device 708, a DAC 704, one or more sensors 712, and memory 714 (FIG. 7). The actuator 706 is coupled with, at least, an imaging-device element 710 (e.g., an image sensor or lens of the imaging device 708). As described above in reference to FIG. 1, the actuator 706 can be associated with predefined calibration data that causes the imaging device 708 to achieve a performance characteristic and/or threshold.

In some embodiments, a method for recalibrating an autofocus actuator includes using the DAC 704 to drive the actuator 706. The DAC 704 operates using a DAC number input loop (e.g., current, voltage, etc. input). A non-limiting example of a DAC input loop includes, using a predefined step size, i) increasing a DAC number from 0 to a minimum input value, ii) increasing the minimum input value to a maximum input value, iii) decreasing the maximum input value to 0, iv) increasing the DAC number from 0 to the maximum input value, v) decreasing from the maximum input value to the minimum input value, and vi) decreasing from the minimum input value to 0. In some embodiments, the multiple loop cycles may be run to gather statistical data. Other DAC number input loop configurations may be used.

The DAC 704 provides a plurality of drive signals (based on the DAC input loop) to the actuator 706. The actuator 706, in response to each drive signal of the plurality of drive signals, causes the imaging-device element 710 to move (e.g., a lens shift or an image sensor shift), and a position sensor of sensors 712 (e.g., a hall sensor, a tunnel magnetoresistance (TMR) sensor, a capacitance sensor, and/or other types of sensors) dynamically measures a position of the imaging-device element 710. The DAC input (to the actuator 706) and the actuator output position (e.g., position of the imaging-device element 710) are collected and stored (e.g., in memory 714 of the system 700). The collected data is shown and represented in an autofocus actuator recalibration plot 300, which includes the maximum input value, the minimum input value, the DAC inputs, and the actuator output positions (e.g., as function of current, voltage, etc.).

In some embodiments, the system 700 formats the DAC inputs and the actuator output positions stored in memory 714 in accordance with a pre-existing format of the predefined calibration data. In some embodiments, the pre-existing format of the predefined calibration data is a lookup table or polynomial model (e.g., used in a factory calibration process). The system 700 performs a curve fitting procedure using predefined calibration data and the DAC input data and the actuator output position data. In particular, the system 700 generates a curve fit using the collected data and the predefined calibration data. A non-limiting example of the curve fit is shown and described in reference to FIG. 1. The system 700, based on the curve fitting procedure, can generate recalibration data, distinct from the predefined calibration data, based, in part, on the displacement data.

In some embodiments, the system 700 associates the actuator 706 with the recalibration data such that the imaging device 708 achieves the performance characteristic. For example, the recalibration data can be used to align in-field performance (e.g. broken line in FIG. 1) with calibrated performance (e.g. solid line in FIG. 1). In some embodiments, the recalibration data is used to update an actuator response function (e.g., lens position as a function of actuation). In some embodiments, the recalibration data and/or the actuator response function are stored in actuator driver memory (e.g., EPROM) and/or within the memory 714 of the system 700.

FIG. 4 illustrates example recalibration of an optical image stabilization actuator, in accordance with some embodiments. The example recalibration process for the OIS actuator is similar to the example recalibration process for the autofocus actuator described in reference to FIG. 3. In contrast to the example recalibration process for the autofocus actuator, which contemplates vertical movements (e.g., imaging-device element 710 relative to actuation), the example recalibration process for the OIS actuator involves lateral (e.g., in-plane) movements (e.g., imaging-device element 710 relative to actuation). The example recalibration process for the OIS actuator can be performed by the system 700 (FIG. 7). As described above in reference to FIG. 1, the actuator 706 of the system 700 can be associated with predefined calibration data that causes the imaging device 708 to achieve a performance characteristic and/or threshold.

In some embodiments, a method for recalibrating an OIS actuator includes using the DAC 704 to drive the actuator 706. The DAC 704 operates using a DAC number input loop (e.g., current, voltage, etc. input). A non-limiting example of a DAC input loop includes, using a predefined step size, i) increasing a DAC number from 0 to a minimum input value, ii) increasing the minimum input value to a maximum input value, iii) decreasing the maximum input value to 0, iv) increasing the DAC number from 0 to the maximum input value, v) decreasing from the maximum input value to the minimum input value, and vi) decreasing from the minimum input value to 0. In some embodiments, the multiple loop cycles may be run to gather statistical data. Other DAC number input loop configurations may be used.

Similar to the example recalibration process for the autofocus actuator described in reference to FIG. 3, the DAC 704 provides a plurality of drive signals (based on the DAC input loop) to the actuator 706. The actuator 706, in response to each drive signal of the plurality of drive signals, causes the imaging-device element 710 to move, and a position sensor of the one or more sensors 712 dynamically measures a position of the imaging-device element 710. The DAC input (to the actuator 706) and the actuator output position (e.g., position of the imaging-device element 710) are collected and stored (e.g., in memory 714 of the system 700). The collected data is shown and represented in an OIS actuator recalibration plot 400, which includes the maximum input value, the minimum input value, the DAC inputs, and the actuator output positions (e.g., as function of current, voltage, etc.).

As described above, the system 700 formats the DAC inputs and the actuator output positions stored in memory 714 in accordance with a pre-existing format of the predefined calibration data. The system 700 performs a curve fitting procedure using predefined calibration data and the DAC input data and the actuator output position data. In particular, the system 700 generates a curve fit using the collected data and the predefined calibration data. A non-limiting example of the curve fit is shown and described in reference to FIG. 1. The system 700, based on the curve fitting procedure, can generate recalibration data, distinct from the predefined calibration data, based, in part, on the displacement data.

In some embodiments, the system 700 associates the actuator 706 with the recalibration data such that the imaging device 708 achieves the performance characteristic. For example, the recalibration data can be used to align in-field performance (e.g. broken line in FIG. 1) with calibrated performance (e.g. solid line in FIG. 1). In some embodiments, the recalibration data is used to update an actuator response function (e.g., lens position as a function of actuation). In some embodiments, the recalibration data and/or the actuator response function are stored in actuator driver memory and/or within the memory 714 of the system 700.

FIG. 5 illustrates recalibration of an autofocus imaging device lens focal length, in accordance with some embodiments. The autofocus imaging device lens focal length recalibration process can be performed by the system 700 (FIG. 7). As described above in reference to FIGS. 1 and 2, the actuator 706 of the system 700 can be associated with predefined calibration data such that the imaging device 708 achieves a performance characteristic and/or threshold. The autofocus imaging device lens focal length recalibration process evaluates and readjusts a relative lens position to achieve accurate focusing of a target object on an image plane. In some embodiment, autofocus imaging device lens focal length recalibration process is performed after an actuator recalibration process (e.g., the example recalibration processes described in reference to FIGS. 3 and 4). Alternatively, or in addition, in some embodiments, autofocus imaging device lens focal length recalibration process is performed independent of an actuator recalibration process.

The autofocus imaging device lens focal length recalibration process utilizes a lens performance recalibration plot 500. The lens performance recalibration plot 500 is similar to the lens performance plot 250 described in FIG. 2. For example, lens performance recalibration plot 500 shows a lens to sensor position (y-axis) as a function of object distance (the x-axis). The autofocus imaging device lens focal length recalibration process divides object distance into a plurality of object distance range groups. For example, as shown by the lens performance recalibration plot 500, the object distance is divided into groups 1 to group n. The plurality of object distance range groups is optimized based on sensor, lens design and focused use cases. In some embodiments, object distance range is shorter at macro, and gradually increases towards infinity, as object distance range is most sensitive near macro.

The autofocus imaging device lens focal length recalibration process includes collecting and/or storing, by the system 700, a number of data points (e.g., lens to sensor position, region of interest (ROI) object distances, DAC numbers (e.g., voltage, current, etc.), etc.) within each object distance range group. The number of discrete datapoints per group may be selected to provide desired resolution and accuracy. For instance, a greater number of datapoints may be selected in groups corresponding to smaller object distances (e.g., Group 1 or Group 2 in FIG. 5) relative to groups corresponding to larger object distances (e.g., Group 3). The number of data points can be dynamically updated with new entries in each range group. In some embodiments, collecting the number of data points includes estimating the ROI object distance and estimating an imaging-device element 710 (e.g., lens and/or image sensor) position based on design properties of the imaging-device element 710 (e.g., lens design). An ROI object distance is estimated using one or more of gaze techniques, depth sensor techniques, and/or other techniques. A position of the imaging-device element 710 can be obtained from the actuator calibration. Then, using the thin-lens equation

$$( e . g . , f = \frac{oi}{o + i} ,$$

as described above with reference to FIG. 2), the focal length f can be updated and calibrated based on a set of image distances (i) and object distances (o).

In some embodiments, collecting the number of data points also includes estimating a required current and/or voltage to imaging-device element 710 to a desired position using the actuator calibrated results (predefined calibration data), converting the required current and/or voltage to DAC number, and providing the DAC number to the actuator 706 (e.g., a controller of the actuator 706) via the DAC 704. In some embodiments, the actuator 706 is a shape memory alloy (SMA) actuators and/or a Voice Coil Motor (VCM) actuator, which are controlled via a current provided by the DAC 704. Alternatively, in some embodiments, the actuator 706 is an electrostatic actuator and/or piezoelectric actuator, which are controlled via a voltage provided by the DAC 704. The actuator 706 deforms (or generates a response) based on the DAC number (e.g., an input DAC current and/or voltage). The system 700 measures the imaging-device element 710 position. For example, the system 700 can measure the imaging-device element 710 position for actuator lens shift or sensor shift.

The autofocus imaging device lens focal length recalibration process further includes replacing a dataset (e.g., an object distance, DAC numbers, imaging-device element 710 displacements (e.g. lens shifts or sensor shifts)) in a respective object distance range group queue. In some embodiments, the data sets are replaced following a First In First Out (FIFO) principle (e.g., group 1 to group 2, group 2 to group 3, group 3 to group n, etc.). The autofocus imaging device lens focal length recalibration process also performs a curve fitting procedure on the data from all groups, to generate a representation of object distance versus lens to sensor position (while adhering to the pre-existing format used within the system 700). In particular, the system 700, as shown by the lens performance recalibration plot 500, generates a curve fit using the collected data (represented by a broken line and discrete circular data point) and the predefined calibration data (represented by a solid line).

Similar to the recalibration processes described above in reference to FIGS. 3 and 4, in some embodiments, the system 700 associates the actuator 706 with the recalibration data such that the imaging device 708 achieves the performance characteristic. For example, the recalibration data can be used to reduce or eliminate the displacement delta (e.g., displacement delta 252; FIG. 2) such that the collected data is aligned with the predefined calibration data. In some embodiments, the recalibration data is used to update an actuator response function (e.g., lens position as a function of actuation). In some embodiments, the recalibration data and/or the actuator response function are stored in actuator driver memory and/or within the memory 714 of the system 700.

FIG. 6 illustrates recalibration of a tunable lens autofocus lens focal length, in accordance with some embodiments. The tunable lens autofocus lens focal length recalibration process can be performed by the system 700 (FIG. 7). As described above in reference to FIGS. 1 and 2, the actuator 706 of the system 700 can be associated with predefined calibration data such that the imaging device 708 achieves a performance characteristic and/or threshold. In some embodiments, the imaging-device element 710 of the imaging device 708 is a tunable lens. For example, the imaging-device element 710 can be a piezoelectric (PZT) actuated tunable lens or other type of tunable lens.

In some embodiments, the actuated tunable lens is able to change a lens surface to change lens optical power. In particular, for a tunable lens, optical power may be tuned in response to a change in lens surface shape, which may be correlated with the capacitance of an associated actuator 706. For example, tunable lens performance plot 600 shows optical power (y-axis) as a function of actuator capacitance (x-axis). Over time, structural mechanical stress changes of the actuated tunable lens and/or lens polymer material changes of the actuated tunable lens change the lens curvature and shifts optical power of the lens's. Additionally, the actuated tunable lens can have one or more nonlinear effects such as piezoelectric hysteresis, thermal drift, moisture ingression, creep, among others that also change performance of the actuated tunable lens. To account for changes of the actuated tunable lens over time (as well as the one or more nonlinear effects), the tunable lens autofocus lens focal length recalibration process is used to update predefined calibration data such that the imaging device 708 achieves a performance characteristic and/or threshold.

In some embodiments, the tunable lens autofocus lens focal length recalibration process includes using the DAC 704 to drive the actuator 706. In some embodiments, the actuator 706 is a piezoelectric or MEMS actuator. The DAC 704 operates using a DAC number input loop (e.g., current, voltage, etc. input). A non-limiting example of a DAC input loop includes, using a predefined step size, setting the DAC number to 0 and increasing the DAC number to a maximum input value, decreasing the DAC umber from the maximum input value to a minimum input value, and returning the DAC number from the minimum input value to 0. In some embodiments, multiple loop cycles may be run to gather statistical data. Other DAC number input loop configurations may be used.

The DAC 704 provides a plurality of drive signals (based on the DAC input loop) to the actuator 706. The actuator 706, in response to each drive signal of the plurality of drive signals, deforms lens with the input actuation DAC. The system 700 measures an actuator capacitance for the actuator 706 and collects and/or stores (e.g., in memory 714) the input DAC and the actuator capacitance. The collected data is shown and represented in a tunable lens recalibration plot 650, which includes the maximum input value, the minimum input value, the DAC inputs, and the actuator capacitance (e.g., as function of voltage).

In some embodiments, the system 700 formats the DAC inputs and the actuator capacitance in accordance with a pre-existing format of the predefined calibration data. As described above in reference to at least FIGS. 3-5, in some embodiments, the pre-existing format of the predefined calibration data is a lookup table or polynomial model (e.g., used in a factory calibration process). The system 700 performs a curve fitting procedure using predefined calibration data (e.g. predefined actuator capacitance data) and the DAC input data and the collected actuator capacitance data. In particular, the system 700 generates a curve fit using the collected data and the predefined calibration data. The system 700, based on the curve fitting procedure, can generate recalibration data, distinct from the predefined calibration data, based, in part, on the displacement data.

In some embodiments, the system 700 associates the actuator 706 with the recalibration data such that the imaging device 708 achieves the performance characteristic. For example, the recalibration data can be used such that in-field or actual optical power of the actuated tunable lens aligns with the calibrated optical power of the actuated tunable lens. In some embodiments, the recalibration data is used to update an actuator response function (e.g., optical power as a function of capacitance). In some embodiments, the recalibration data and/or the actuator response function are stored in actuator driver memory (e.g., EPROM) and/or within the memory 714 of the system 700.

Tuning to FIG. 7, an example system is illustrated, in accordance with some embodiments. The system 700 includes one or more processors 702, memory 714, actuators 706, DACs 705, sensor 712, and imaging devices 708. The imaging devices 708 can include one or more imaging-device elements 710, such as a lens, an image sensor, etc. In some embodiments, one or more of the processors 702, memory 714, the actuators 706, the DACs 705, and the sensor 712 are included within the imaging device 708. Alternatively, in some embodiments, one or more of the processors 702, memory 714, the actuators 706, the DACs 705, and the sensor 712 are coupled with the imaging device 710. As described herein, the actuators 706 can include respective memory (e.g., EPROM) storing calibration data and/or data for controlling operation of the actuators 706). The actuators 706 can be coupled with the imaging-device elements 710 such that, when the actuators 706 are actuated, the imaging-device elements 710 is caused to move. The DAC 704 provides a plurality of drive signals for causing the actuators 706 to be actuated. The one or more sensors 712 can be position sensors that measure movement of the imaging-device elements 710.

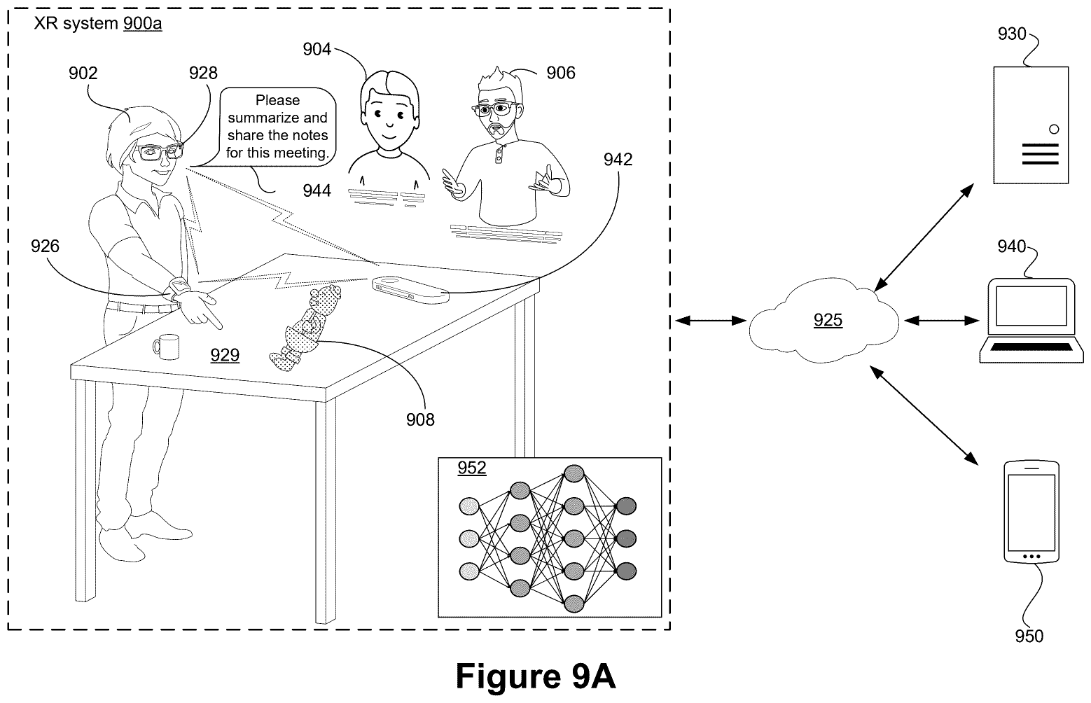

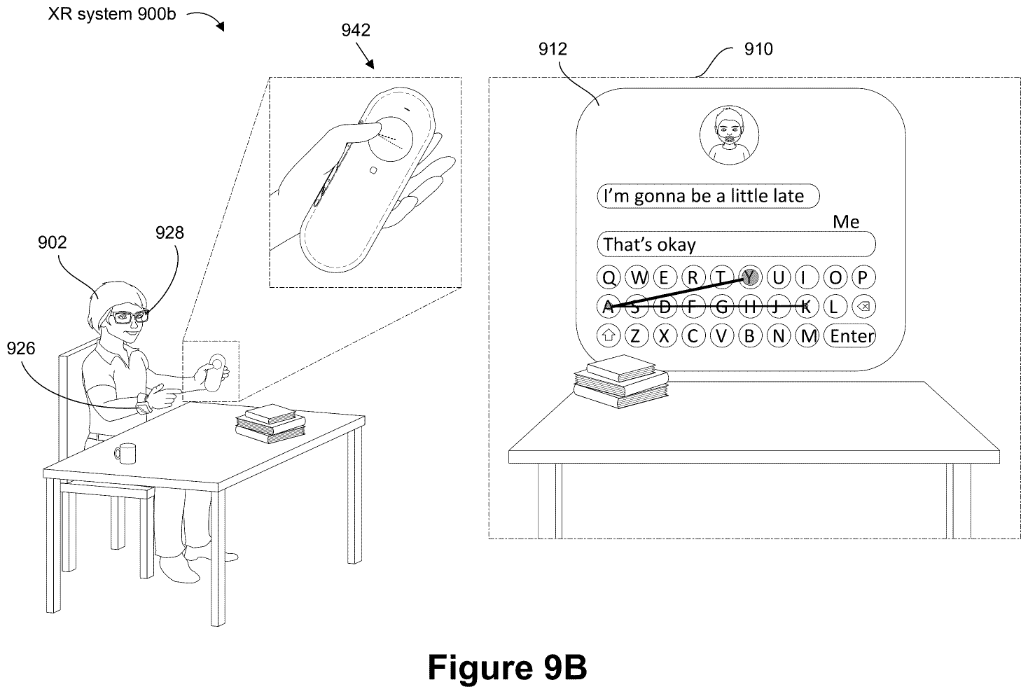

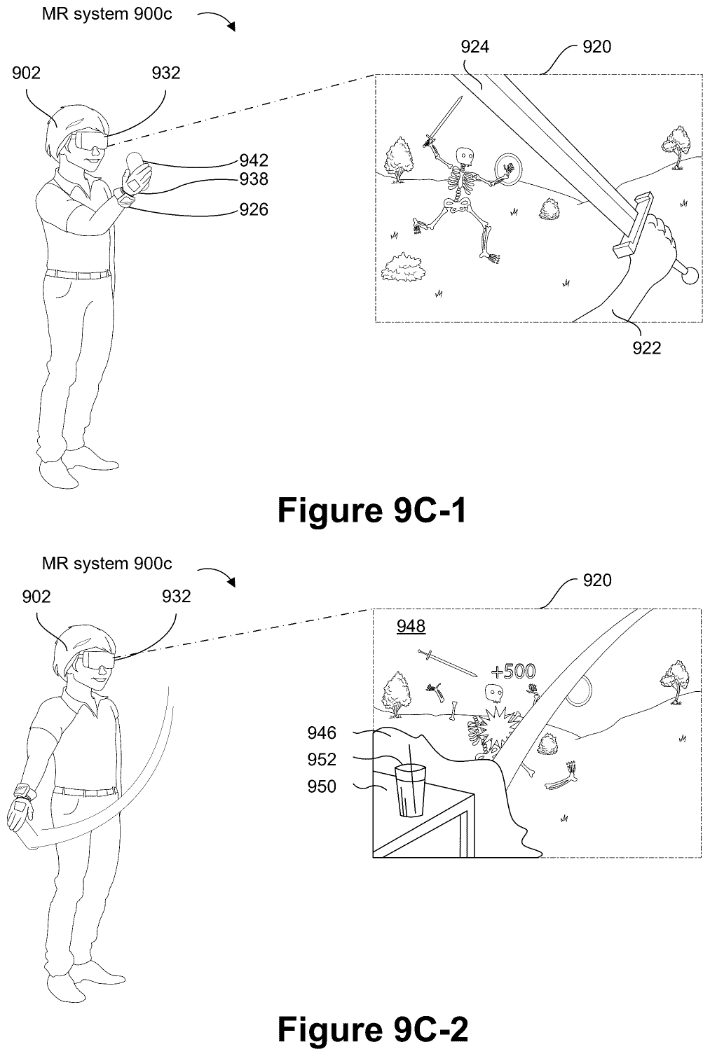

The system 700 is configured to perform one or more of the recalibration processes described above in reference to, at least, FIGS. 3-6. The system 700 can be included, or part of, an XR system 900 or device of the XR system 900 (FIGS. 9A-9C). For example, the system 700 can be part of or included in a head-wearable device 928, a wrist-wearable device 926, an handheld intermediary processing device 942, a mobile device 950, and/or other devices described below in reference to FIGS. 9A-9C.

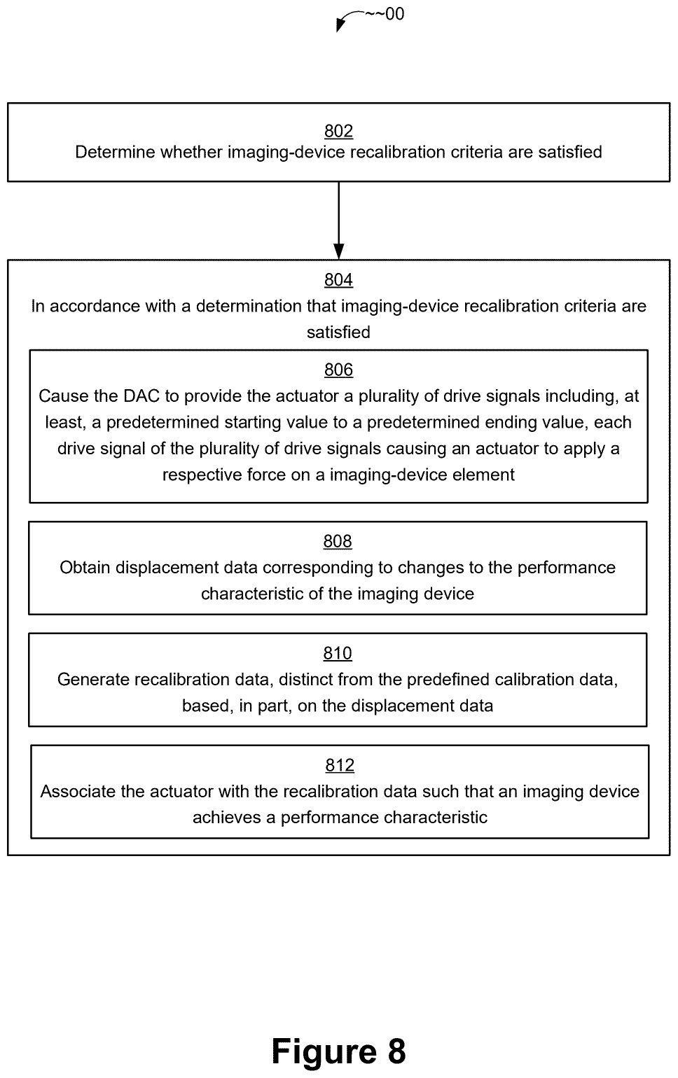

FIG. 8 illustrates a flow diagram of a method of calibrating performance of an imaging device, in accordance with some embodiments. Operations (e.g., steps) of the method 800 can be performed by one or more processors (e.g., central processing unit and/or MCU) of a system (e.g., XR systems 900 (FIGS. 9A-9C) or system 700 (FIG. 7)). At least some of the operations shown in FIG. 8 correspond to instructions stored in a computer memory or computer-readable storage medium (e.g., storage, RAM, and/or memory). Operations of the method 800 can be performed by a single device alone or in conjunction with one or more processors and/or hardware components of another communicatively coupled device (e.g., a head-wearable device 928, a wrist-wearable device 926, an handheld intermediary processing device 942, a mobile device 950, and/or other devices described below in reference to FIGS. 9A-9C) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(A1) The method 800 occurs at a system including one or more processors communicatively coupled with an imaging device including an imaging-device element, an actuator coupled with, at least, the imaging-device element and associated with predefined calibration data that causes the imaging device to achieve a performance characteristic, a DAC, and memory. The system can be part of a wearable device, such as a head-wearable device and wrist-wearable device, and/or other devices described herein.

In some embodiments, the method 800 includes determining (802) whether imaging-device recalibration criteria are satisfied. The method 800 includes, in accordance with a determination that imaging-device recalibration criteria are satisfied (804), causing (806) the DAC to provide the actuator a plurality of drive signals. The plurality of drive signals includes, at least, drive signals with a predetermined starting value to a predetermined ending value. Each drive signal of the plurality of drive signals causes the actuator to apply a respective force on the imaging-device element (e.g., move the imaging-device element and/or deform the imaging-device element).

The method 800 also includes obtaining (808) displacement data corresponding to changes to the performance characteristic of the imaging device, generating (810) recalibration data, distinct from the predefined calibration data, based, in part, on the displacement data, and associating (812) the actuator with the recalibration data such that the imaging device achieves the performance characteristic.

For example, as described above in reference to FIGS. 3-6, a DAC provides drive signals to an actuator and the actuator causes movement and/or deformation of the imaging-device element. The system collects data related to changes to an imaging-device element position, capacitance, and/or other properties, which is used to calibrate an actuator and/or performance of an imaging device.
(A2) In some embodiments of A1, the imaging-device recalibration criteria includes one or more of a predefined calibration interval, one or more control algorithm predefined thresholds, a request trigger, and underperformance thresholds.
(A3) In some embodiments of any of A1-A2, the system includes one or more sensors communicatively coupled with the one or more processors. The respective force on the imaging-device element by the actuator causes a change to a position of the imaging-device element and the displacement data includes respective position data for the imaging-device element (captured by the one or more sensors). For example, as shown and described above in reference to FIGS. 3 and 4, an (autofocus and/or OIS) actuator can be recalibrated based on changes to a position of an imaging-device element.
(A4) In some embodiments of any of A1-A3, the respective force on the imaging-device element by the actuator causes deformation of the imaging-device element, and the displacement data includes capacitance data for the imaging-device element based on respective deformations of the imaging-device element. For example, as shown and described above in reference to FIG. 6, the imaging-device element can be a tunable lens and the actuator can be calibrated based on collected capacitance data.
(A5) In some embodiments of any of A1-A4, the method 800 includes, after calibrating the actuator, determining object distance range groups based on an object distances for the imaging device, for each object distance range group of the object distance range groups, determining, based on one or more of an object distance, an image distance, and properties of the imaging-device element, one or more of values for another plurality of drive signals to move the imaging-device element to a predefined position based on the respective predefined calibration data, and causing the DAC to provide the actuator the other plurality of drive signals. Each object distance range group is associated with respective predefined calibration data of the predefined calibration data. The other plurality of drive signals include, at least, other drive signals with another predetermined starting value to another predetermined ending value. Each of the other drive signals of the other plurality of drive signals causes the actuator to move the imaging-device element to a respective position. The method 800 also includes, for each object distance range group, generating respective recalibration data, distinct from the respective predefined calibration data, based, in part, on the respective displacement data, and associating the actuator with the respective recalibration data such that the imaging device achieves the performance characteristic. For example, as shown and described above in reference to FIG. 5, a focal length of a lens of an imaging device can be recalibrated based on data collected for distinct object distance range groups.
(A6) In some embodiments of any of A1-A5, the imaging-device element is one of a plurality of imaging-device elements, the plurality of imaging-device elements including one or more of a lens and an image sensor.
(A7) In some embodiments of any of A1-A6, the imaging device includes one or more of autofocus and optical image stabilization.
(A8) In some embodiments of any of A1-A7, the imaging device actuator is one of a voice coil motor actuator, a piezoelectric actuator, or a shape memory alloy actuator.
(A9) In some embodiments of any of A1-A8, the system includes one or more sensors communicatively coupled with the one or more processors. The one or more sensors include one or more of hall effect sensors, tunnel magnetoresistance sensors, capacitive sensors, inductive sensors, ultrasonic sensors, and potentiometric sensors.
(A10) In some embodiments of any of A1-A9, wherein each drive signal is incremented by a predetermined step.
(A11) In some embodiments of A10, wherein the plurality of drive signals are incremented by the predetermined step from one or more of i) zero to a predetermined minimum value, the predetermined minimum value to a predetermined maximum value, the predetermined maximum value to zero, zero to the predetermined maximum value, the predetermined maximum value to the predetermined minimum value, and the predetermined minimum value to zero.
(B1) In accordance with some embodiments, a method includes initiating a re-calibration routine for a device (e.g., an imaging device). The routine constituting coupling an actuator to a workpiece (e.g., a lens or an image sensor). The actuator is configured to apply a force to the workpiece. The routine includes applying a drive signal to the actuator. The drive signal is stepped from a minimum input value to a maximum input value. The routine includes measuring a response of the workpiece to the applied drive signal at each input value to form a calibration dataset, and determining a fit to the calibration dataset. For example, as described above in reference to FIGS. 3-6, a DAC provides drive signals to an actuator and the actuator causes movement and/or deformation of the imaging-device element. The system collects data related to changes to an imaging-device element position, capacitance, and/or other properties, which is used to calibrate an actuator and/or performance of an imaging device.
(B2) In some embodiments of B1, the re-calibration routine is initiated by a user.
(B3) In some embodiments of any of B1-B2, the re-calibration routine is initiated by a control algorithm of the device in response to a system operation time exceeding a pre-determined threshold.
(B4) In some embodiments of any of B1-B3, the re-calibration routine is initiated at pre-determined time intervals.
(B5) In some embodiments of any of B1-B4, the re-calibration routine is initiated following a pre-determined number of device operations.
(B6) In some embodiments of any of B1-B5, the workpiece includes a lens.
(B7) In some embodiments of any of B1-B6, the workpiece includes an image sensor.
(B8) In some embodiments of any of B1-B7, measuring the response includes measuring a relative position of the workpiece. For example, as shown and described above in reference to FIGS. 3 and 4, an (autofocus and/or OIS) actuator can be recalibrated based on changes to a position of an imaging-device element.
(B9) In some embodiments of any of B1-B8, measuring the response includes measuring a relative position of the workpiece using a position sensor selected from a Hall sensor, a TMR sensor, and a capacitance sensor.
(B10) In some embodiments of any of B1-B9, measuring the response includes measuring a relative position of the workpiece using one or more of a depth sensor (e.g., stereo cameras, ToF sensors, etc.).
(C1) In accordance with some embodiments, a system that includes one or more of a wrist wearable device (or a plurality of wrist-wearable devices), a pair of augmented-reality glasses (or other head-wearable device described herein), an imaging device, and an handheld intermediary processing device, and the system is configured to perform operations corresponding to any of A1-B10.
(D1) In accordance with some embodiments, a non-transitory computer readable storage medium including instructions that, when executed by a computing device in communication with one or more of a pair of augmented-reality glasses (or other head-wearable device described herein), a wrist-wearable device, an handheld intermediary processing device, and an imaging device, cause the computer device to perform operations corresponding to any of A1-B10.
(E1) In accordance with some embodiments, a method of operating one or more of a pair of augmented-reality glasses (or other head-wearable device described herein), a wrist-wearable device, an handheld intermediary processing device, and an imaging device, including operations that correspond to any of A1-B10.
(F1) In accordance with some embodiments, a wearable device (head-worn device or wrist-wearable device) configured to perform or cause performance of operations corresponding to any of A1-B10.
(G1) In accordance with some embodiments, a means for performing or causing performance of operations corresponding to any of A1-B10.
(H1) In accordance with some embodiments, an intermediary processing device (e.g., configured to offload processing operations for a wearable device) configured to perform or cause performance of operations corresponding to any of A1-B10.
(I1) In accordance with some embodiments, an electronic device configured to perform or cause performance of operations corresponding to any of A1-B10.

Embodiments of the present disclosure may include or be implemented in conjunction with various types of XR systems.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

FIGS. 9A 9B, 9C-1, and 9C-2, illustrate example XR systems that include AR and MR systems, in accordance with some embodiments. FIG. 9A shows a first XR system 900a and first example user interactions using a wrist-wearable device 926, a head-wearable device (e.g., AR device 928), and/or a HIPD 942. FIG. 9B shows a second XR system 900b and second example user interactions using a wrist-wearable device 926, AR device 928, and/or an HIPD 942. FIGS. 9C-1 and 9C-2 show a third MR system 900c and third example user interactions using a wrist-wearable device 926, a head-wearable device (e.g., an MR device such as a VR device), and/or an HIPD 942. As the skilled artisan will appreciate upon reading the descriptions provided herein, the above-example AR and MR systems (described in detail below) can perform various functions and/or operations.

The wrist-wearable device 926, the head-wearable devices, and/or the HIPD 942 can communicatively couple via a network 925 (e.g., cellular, near field, Wi-Fi, personal area network, wireless LAN). Additionally, the wrist-wearable device 926, the head-wearable device, and/or the HIPD 942 can also communicatively couple with one or more servers 930, computers 940 (e.g., laptops, computers), mobile devices 950 (e.g., smartphones, tablets), and/or other electronic devices via the network 925 (e.g., cellular, near field, Wi-Fi, personal area network, wireless LAN). Similarly, a smart textile-based garment, when used, can also communicatively couple with the wrist-wearable device 926, the head-wearable device(s), the HIPD 942, the one or more servers 930, the computers 940, the mobile devices 950, and/or other electronic devices via the network 925 to provide inputs.

Turning to FIG. 9A, a user 902 is shown wearing the wrist-wearable device 926 and the AR device 928 and having the HIPD 942 on their desk. The wrist-wearable device 926, the AR device 928, and the HIPD 942 facilitate user interaction with an AR environment. In particular, as shown by the first AR system 900a, the wrist-wearable device 926, the AR device 928, and/or the HIPD 942 cause presentation of one or more avatars 904, digital representations of contacts 906, and virtual objects 908. As discussed below, the user 902 can interact with the one or more avatars 904, digital representations of the contacts 906, and virtual objects 908 via the wrist-wearable device 926, the AR device 928, and/or the HIPD 942. In addition, the user 902 is also able to directly view physical objects in the environment, such as a physical table 929, through transparent lens(es) and waveguide(s) of the AR device 928. Alternatively, an MR device could be used in place of the AR device 928 and a similar user experience can take place, but the user would not be directly viewing physical objects in the environment, such as table 929, and would instead be presented with a virtual reconstruction of the table 929 produced from one or more sensors of the MR device (e.g., an outward facing camera capable of recording the surrounding environment).

The user 902 can use any of the wrist-wearable device 926, the AR device 928 (e.g., through physical inputs at the AR device and/or built-in motion tracking of a user's extremities), a smart-textile garment, externally mounted extremity tracking device, the HIPD 942 to provide user inputs, etc. For example, the user 902 can perform one or more hand gestures that are detected by the wrist-wearable device 926 (e.g., using one or more EMG sensors and/or IMUs built into the wrist-wearable device) and/or AR device 928 (e.g., using one or more image sensors or cameras) to provide a user input. Alternatively, or additionally, the user 902 can provide a user input via one or more touch surfaces of the wrist-wearable device 926, the AR device 928, and/or the HIPD 942, and/or voice commands captured by a microphone of the wrist-wearable device 926, the AR device 928, and/or the HIPD 942. The wrist-wearable device 926, the AR device 928, and/or the HIPD 942 include an artificially intelligent digital assistant to help the user in providing a user input (e.g., completing a sequence of operations, suggesting different operations or commands, providing reminders, confirming a command). For example, the digital assistant can be invoked through an input occurring at the AR device 928 (e.g., via an input at a temple arm of the AR device 928). In some embodiments, the user 902 can provide a user input via one or more facial gestures and/or facial expressions. For example, cameras of the wrist-wearable device 926, the AR device 928, and/or the HIPD 942 can track the user 902's eyes for navigating a user interface.

The wrist-wearable device 926, the AR device 928, and/or the HIPD 942 can operate alone or in conjunction to allow the user 902 to interact with the AR environment. In some embodiments, the HIPD 942 is configured to operate as a central hub or control center for the wrist-wearable device 926, the AR device 928, and/or another communicatively coupled device. For example, the user 902 can provide an input to interact with the AR environment at any of the wrist-wearable device 926, the AR device 928, and/or the HIPD 942, and the HIPD 942 can identify one or more back-end and front-end tasks to cause the performance of the requested interaction and distribute instructions to cause the performance of the one or more back-end and front-end tasks at the wrist-wearable device 926, the AR device 928, and/or the HIPD 942. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 942 can perform the back-end tasks and provide the wrist-wearable device 926 and/or the AR device 928 operational data corresponding to the performed back-end tasks such that the wrist-wearable device 926 and/or the AR device 928 can perform the front-end tasks. In this way, the HIPD 942, which has more computational resources and greater thermal headroom than the wrist-wearable device 926 and/or the AR device 928, performs computationally intensive tasks and reduces the computer resource utilization and/or power usage of the wrist-wearable device 926 and/or the AR device 928.

In the example shown by the first AR system 900a, the HIPD 942 identifies one or more back-end tasks and front-end tasks associated with a user request to initiate an AR video call with one or more other users (represented by the avatar 904 and the digital representation of the contact 906) and distributes instructions to cause the performance of the one or more back-end tasks and front-end tasks. In particular, the HIPD 942 performs back-end tasks for processing and/or rendering image data (and other data) associated with the AR video call and provides operational data associated with the performed back-end tasks to the AR device 928 such that the AR device 928 performs front-end tasks for presenting the AR video call (e.g., presenting the avatar 904 and the digital representation of the contact 906).

In some embodiments, the HIPD 942 can operate as a focal or anchor point for causing the presentation of information. This allows the user 902 to be generally aware of where information is presented. For example, as shown in the first AR system 900a, the avatar 904 and the digital representation of the contact 906 are presented above the HIPD 942. In particular, the HIPD 942 and the AR device 928 operate in conjunction to determine a location for presenting the avatar 904 and the digital representation of the contact 906. In some embodiments, information can be presented within a predetermined distance from the HIPD 942 (e.g., within five meters). For example, as shown in the first AR system 900a, virtual object 908 is presented on the desk some distance from the HIPD 942. Similar to the above example, the HIPD 942 and the AR device 928 can operate in conjunction to determine a location for presenting the virtual object 908. Alternatively, in some embodiments, presentation of information is not bound by the HIPD 942. More specifically, the avatar 904, the digital representation of the contact 906, and the virtual object 908 do not have to be presented within a predetermined distance of the HIPD 942. While an AR device 928 is described working with an HIPD, an MR headset can be interacted with in the same way as the AR device 928.

User inputs provided at the wrist-wearable device 926, the AR device 928, and/or the HIPD 942 are coordinated such that the user can use any device to initiate, continue, and/or complete an operation. For example, the user 902 can provide a user input to the AR device 928 to cause the AR device 928 to present the virtual object 908 and, while the virtual object 908 is presented by the AR device 928, the user 902 can provide one or more hand gestures via the wrist-wearable device 926 to interact and/or manipulate the virtual object 908. While an AR device 928 is described working with a wrist-wearable device 926, an MR headset can be interacted with in the same way as the AR device 928.

Integration of Artificial Intelligence with XR Systems

FIG. 9A illustrates an interaction in which an artificially intelligent virtual assistant can assist in requests made by a user 902. The AI virtual assistant can be used to complete open-ended requests made through natural language inputs by a user 902. For example, in FIG. 9A the user 902 makes an audible request 944 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 9A also illustrates an example neural network 952 used in Artificial Intelligence applications. Uses of Artificial Intelligence (AI) are varied and encompass many different aspects of the devices and systems described herein. AI capabilities cover a diverse range of applications and deepen interactions between the user 902 and user devices (e.g., the AR device 928, an MR device 932, the HIPD 942, the wrist-wearable device 926). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 902 can interact with an AI model through natural language inputs captured by a voice sensor, text inputs, or any other input modality that accepts natural language and/or a corresponding voice sensor module. In another instance, input is provided by tracking the eye gaze of a user 902 via a gaze tracker module. Additionally, the AI model can also receive inputs beyond those supplied by a user 902. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 928) or from multiple devices that are in communication with each other (e.g., a system that includes at least two of an AR device 928, an MR device 932, the HIPD 942, the wrist-wearable device 926, etc.). The AI model can also access additional information (e.g., one or more servers 930, the computers 940, the mobile devices 950, and/or other electronic devices) via a network 925.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 928, an MR device 932, the HIPD 942, the wrist-wearable device 926) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 928, an MR device 932, the HIPD 942, the wrist-wearable device 926), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 942), haptic feedback can provide information to the user 902. An AI model can also use the inputs described above to determine the appropriate modality and device(s) to present content to the user (e.g., a user walking on a busy road can be presented with an audio output instead of a visual output to avoid distracting the user 902).

### Example Augmented Reality Interaction

FIG. 9B shows the user 902 wearing the wrist-wearable device 926 and the AR device 928 and holding the HIPD 942. In the second AR system 900b, the wrist-wearable device 926, the AR device 928, and/or the HIPD 942 are used to receive and/or provide one or more messages to a contact of the user 902. In particular, the wrist-wearable device 926, the AR device 928, and/or the HIPD 942 detect and coordinate one or more user inputs to initiate a messaging application and prepare a response to a received message via the messaging application.

In some embodiments, the user 902 initiates, via a user input, an application on the wrist-wearable device 926, the AR device 928, and/or the HIPD 942 that causes the application to initiate on at least one device. For example, in the second AR system 900b the user 902 performs a hand gesture associated with a command for initiating a messaging application (represented by messaging user interface 912); the wrist-wearable device 926 detects the hand gesture; and, based on a determination that the user 902 is wearing the AR device 928, causes the AR device 928 to present a messaging user interface 912 of the messaging application. The AR device 928 can present the messaging user interface 912 to the user 902 via its display (e.g., as shown by user 902's field of view 910). In some embodiments, the application is initiated and can be run on the device (e.g., the wrist-wearable device 926, the AR device 928, and/or the HIPD 942) that detects the user input to initiate the application, and the device provides another device operational data to cause the presentation of the messaging application. For example, the wrist-wearable device 926 can detect the user input to initiate a messaging application, initiate and run the messaging application, and provide operational data to the AR device 928 and/or the HIPD 942 to cause presentation of the messaging application. Alternatively, the application can be initiated and run at a device other than the device that detected the user input. For example, the wrist-wearable device 926 can detect the hand gesture associated with initiating the messaging application and cause the HIPD 942 to run the messaging application and coordinate the presentation of the messaging application.

Further, the user 902 can provide a user input provided at the wrist-wearable device 926, the AR device 928, and/or the HIPD 942 to continue and/or complete an operation initiated at another device. For example, after initiating the messaging application via the wrist-wearable device 926 and while the AR device 928 presents the messaging user interface 912, the user 902 can provide an input at the HIPD 942 to prepare a response (e.g., shown by the swipe gesture performed on the HIPD 942). The user 902's gestures performed on the HIPD 942 can be provided and/or displayed on another device. For example, the user 902's swipe gestures performed on the HIPD 942 are displayed on a virtual keyboard of the messaging user interface 912 displayed by the AR device 928.

In some embodiments, the wrist-wearable device 926, the AR device 928, the HIPD 942, and/or other communicatively coupled devices can present one or more notifications to the user 902. The notification can be an indication of a new message, an incoming call, an application update, a status update, etc. The user 902 can select the notification via the wrist-wearable device 926, the AR device 928, or the HIPD 942 and cause presentation of an application or operation associated with the notification on at least one device. For example, the user 902 can receive a notification that a message was received at the wrist-wearable device 926, the AR device 928, the HIPD 942, and/or other communicatively coupled device and provide a user input at the wrist-wearable device 926, the AR device 928, and/or the HIPD 942 to review the notification, and the device detecting the user input can cause an application associated with the notification to be initiated and/or presented at the wrist-wearable device 926, the AR device 928, and/or the HIPD 942.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 928 can present to the user 902 game application data and the HIPD 942 can use a controller to provide inputs to the game. Similarly, the user 902 can use the wrist-wearable device 926 to initiate a camera of the AR device 928, and the user can use the wrist-wearable device 926, the AR device 928, and/or the HIPD 942 to manipulate the image capture (e.g., zoom in or out, apply filters) and capture image data.

While an AR device 928 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 9C-1 and 9C-2, the user 902 is shown wearing the wrist-wearable device 926 and an MR device 932 (e.g., a device capable of providing either an entirely VR experience or an MR experience that displays object(s) from a physical environment at a display of the device) and holding the HIPD 942. In the third AR system 900c, the wrist-wearable device 926, the MR device 932, and/or the HIPD 942 are used to interact within an MR environment, such as a VR game or other MR/VR application. While the MR device 932 presents a representation of a VR game (e.g., first MR game environment 920) to the user 902, the wrist-wearable device 926, the MR device 932, and/or the HIPD 942 detect and coordinate one or more user inputs to allow the user 902 to interact with the VR game.

In some embodiments, the user 902 can provide a user input via the wrist-wearable device 926, the MR device 932, and/or the HIPD 942 that causes an action in a corresponding MR environment. For example, the user 902 in the third MR system 900c (shown in FIG. 9C-1) raises the HIPD 942 to prepare for a swing in the first MR game environment 920. The MR device 932, responsive to the user 902 raising the HIPD 942, causes the MR representation of the user 922 to perform a similar action (e.g., raise a virtual object, such as a virtual sword 924). In some embodiments, each device uses respective sensor data and/or image data to detect the user input and provide an accurate representation of the user 902's motion. For example, image sensors (e.g., SLAM cameras or other cameras) of the HIPD 942 can be used to detect a position of the HIPD 942 relative to the user 902's body such that the virtual object can be positioned appropriately within the first MR game environment 920; sensor data from the wrist-wearable device 926 can be used to detect a velocity at which the user 902 raises the HIPD 942 such that the MR representation of the user 922 and the virtual sword 924 are synchronized with the user 902's movements; and image sensors of the MR device 932 can be used to represent the user 902's body, boundary conditions, or real-world objects within the first MR game environment 920.

In FIG. 9C-2, the user 902 performs a downward swing while holding the HIPD 942. The user 902's downward swing is detected by the wrist-wearable device 926, the MR device 932, and/or the HIPD 942 and a corresponding action is performed in the first MR game environment 920. In some embodiments, the data captured by each device is used to improve the user's experience within the MR environment. For example, sensor data of the wrist-wearable device 926 can be used to determine a speed and/or force at which the downward swing is performed and image sensors of the HIPD 942 and/or the MR device 932 can be used to determine a location of the swing and how it should be represented in the first MR game environment 920, which, in turn, can be used as inputs for the MR environment (e.g., game mechanics, which can use detected speed, force, locations, and/or aspects of the user 902's actions to classify a user's inputs (e.g., user performs a light strike, hard strike, critical strike, glancing strike, miss) or calculate an output (e.g., amount of damage)).

FIG. 9C-2 further illustrates that a portion of the physical environment is reconstructed and displayed at a display of the MR device 932 while the MR game environment 920 is being displayed. In this instance, a reconstruction of the physical environment 946 is displayed in place of a portion of the MR game environment 920 when object(s) in the physical environment are potentially in the path of the user (e.g., a collision with the user and an object in the physical environment are likely). Thus, this example MR game environment 920 includes (i) an immersive VR portion 948 (e.g., an environment that does not have a corollary counterpart in a nearby physical environment) and (ii) a reconstruction of the physical environment 946 (e.g., table 950 and cup 952). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 926, the MR device 932, and/or the HIPD 942 are described as detecting user inputs, in some embodiments, user inputs are detected at a single device (with the single device being responsible for distributing signals to the other devices for performing the user input). For example, the HIPD 942 can operate an application for generating the first MR game environment 920 and provide the MR device 932 with corresponding data for causing the presentation of the first MR game environment 920, as well as detect the user 902's movements (while holding the HIPD 942) to cause the performance of corresponding actions within the first MR game environment 920. Additionally or alternatively, in some embodiments, operational data (e.g., sensor data, image data, application data, device data, and/or other data) of one or more devices is provided to a single device (e.g., the HIPD 942) to process the operational data and cause respective devices to perform an action associated with processed operational data.

In some embodiments, the user 902 can wear a wrist-wearable device 926, wear an MR device 932, wear smart textile-based garments 938 (e.g., wearable haptic gloves), and/or hold an HIPD 942 device. In this embodiment, the wrist-wearable device 926, the MR device 932, and/or the smart textile-based garments 938 are used to interact within an MR environment (e.g., any AR or MR system described above in reference to FIGS. 9A-9B). While the MR device 932 presents a representation of an MR game (e.g., second MR game environment 920) to the user 902, the wrist-wearable device 926, the MR device 932, and/or the smart textile-based garments 938 detect and coordinate one or more user inputs to allow the user 902 to interact with the MR environment.

In some embodiments, the user 902 can provide a user input via the wrist-wearable device 926, an HIPD 942, the MR device 932, and/or the smart textile-based garments 938 that causes an action in a corresponding MR environment. In some embodiments, each device uses respective sensor data and/or image data to detect the user input and provide an accurate representation of the user 902's motion. While four different input devices are shown (e.g., a wrist-wearable device 926, an MR device 932, an HIPD 942, and a smart textile-based garment 938) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 938) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 938 can be used in conjunction with an MR device and/or an HIPD 942.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 9A-9C-2 provided above are intended to augment the description provided in reference to FIGS. 1-8. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A system, comprising:
one or more processors communicatively coupled with:
an imaging device including an imaging-device element,
an actuator coupled with, at least, the imaging-device element, wherein the actuator is associated with predefined calibration data that causes the imaging device to achieve a performance characteristic, and
a digital-to-analog converter (DAC); and
memory including executable instructions that, when executed by the one or more processors, cause the one or more processors to perform:
in accordance with a determination that imaging-device recalibration criteria are satisfied:
causing the DAC to provide the actuator a plurality of drive signals including, at least, drive signals with a predetermined starting value to a predetermined ending value, wherein each drive signal of the plurality of drive signals causes the actuator to apply a respective force on the imaging-device element,
obtaining displacement data corresponding to changes to the performance characteristic of the imaging device,
generating recalibration data, distinct from the predefined calibration data, based, in part, on the displacement data, and
associating the actuator with the recalibration data such that the imaging device achieves the performance characteristic.

2. The system of claim 1, wherein the imaging-device recalibration criteria includes one or more of a predefined calibration interval, one or more control algorithm predefined thresholds, a request trigger, and underperformance thresholds.

3. The system of claim 1, further comprising one or more sensors communicatively coupled with the one or more processors, and wherein:
the respective force on the imaging-device element by the actuator causes a change to a position of the imaging-device element; and
the displacement data includes respective position data for the imaging-device element captured by the one or more sensors.

4. The system of claim 1, wherein:
the respective force on the imaging-device element by the actuator causes deformation of the imaging-device element; and
the displacement data includes capacitance data for the imaging-device element based on respective deformations of the imaging-device element.

5. The system of claim 1, wherein the instructions, when executed by the one or more processors, further cause the one or more processors to perform:
after calibrating the actuator:
determining object distance range groups based on an object distances for the imaging device, wherein each object distance range group is associated with respective predefined calibration data of the predefined calibration data, and
for each object distance range group of the object distance range groups, determining, based on one or more of an object distance, an image distance, and properties of the imaging-device element, one or more of values for another plurality of drive signals to move the imaging-device element to a predefined position based on the respective predefined calibration data, and
causing the DAC to provide the actuator the other plurality of drive signals including, at least, other drive signals with another predetermined starting value to another predetermined ending value, wherein each of the other drive signals of the other plurality of drive signals causes the actuator to move the imaging-device element to a respective position; and
for each object distance range group:
generating respective recalibration data, distinct from the respective predefined calibration data, based, in part, on the respective displacement data, and
associating the actuator with the respective recalibration data such that the imaging device achieves the performance characteristic.

6. The system of claim 1, wherein the imaging-device element is one of a plurality of imaging-device elements, the plurality of imaging-device elements including one or more of a lens and an image sensor.

7. The system of claim 1, wherein the imaging device includes one or more of autofocus and optical image stabilization.

8. The system of claim 1, wherein the imaging device actuator is one of a voice coil motor actuator, a piezoelectric actuator, or a shape memory alloy actuator.

9. The system of claim 1, further comprising:
one or more sensors communicatively coupled with the one or more processors, wherein the one or more sensors include one or more of hall effect sensors, tunnel magnetoresistance sensors, capacitive sensors, inductive sensors, ultrasonic sensors, and potentiometric sensors.

10. A non-transitory computer readable storage medium including instructions that, when executed by a computing device in communication with an imaging device, cause the computing device to perform:
in accordance with a determination that imaging-device recalibration criteria are satisfied:
causing a digital-to-analog converter (DAC) to provide an actuator a plurality of drive signals including, at least, drive signals with a predetermined starting value to a predetermined ending value, wherein:
the actuator is associated with predefined calibration data that causes the imaging device to achieve a performance characteristic; and
each drive signal of the plurality of drive signals causes the actuator to apply a respective force on an imaging-device element of the imaging device,
obtaining displacement data corresponding to changes to the performance characteristic of the imaging device,
generating recalibration data, distinct from the predefined calibration data, based, in part, on the displacement data, and
associating the actuator with the recalibration data such that the imaging device achieves the performance characteristic.

11. The non-transitory computer readable storage medium of claim 10, wherein the imaging-device recalibration criteria includes one or more of a predefined calibration interval, one or more control algorithm predefined thresholds, a request trigger, and underperformance thresholds.

12. The non-transitory computer readable storage medium of claim 10, wherein:
the respective force on the imaging-device element by the actuator causes a change to a position of the imaging-device element; and
the displacement data includes respective position data for the imaging-device element.

13. The non-transitory computer readable storage medium of claim 10, wherein:
the respective force on the imaging-device element by the actuator causes deformation of the imaging-device element; and
the displacement data includes capacitance data for the imaging-device element based on respective deformations of the imaging-device element.

14. The non-transitory computer readable storage medium of claim 10, wherein the instructions, when executed by the computing device, further cause the computing device to perform:
after calibrating the actuator:
determining object distance range groups based on an object distances for the imaging device, wherein each object distance range group is associated with respective predefined calibration data of the predefined calibration data, and
for each object distance range group of the object distance range groups, determining, based on one or more of an object distance, an image distance, and properties of the imaging-device element, one or more of values for another plurality of drive signals to move the imaging-device element to a predefined position based on the respective predefined calibration data, and
causing the DAC to provide the actuator the other plurality of drive signals including, at least, other drive signals with another predetermined starting value to another predetermined ending value, wherein each of the other drive signals of the other plurality of drive signals causes the actuator to move the imaging-device element to a respective position; and
for each object distance range group:
generating respective recalibration data, distinct from the respective predefined calibration data, based, in part, on the respective displacement data, and
associating the actuator with the respective recalibration data such that the imaging device achieves the performance characteristic.

15. The non-transitory computer readable storage medium of claim 10, wherein the imaging-device element is one of a plurality of imaging-device elements, the plurality of imaging-device elements including one or more of a lens and an image sensor.

16. A method, comprising:
in accordance with a determination that imaging-device recalibration criteria are satisfied:
causing a digital-to-analog converter (DAC) to provide an actuator a plurality of drive signals including, at least, drive signals with a predetermined starting value to a predetermined ending value, wherein:
the actuator is associated with predefined calibration data that causes an imaging device to achieve a performance characteristic; and
each drive signal of the plurality of drive signals causes the actuator to apply a respective force on an imaging-device element of the imaging device,
obtaining displacement data corresponding to changes to the performance characteristic of the imaging device,
generating recalibration data, distinct from the predefined calibration data, based, in part, on the displacement data, and
associating the actuator with the recalibration data such that the imaging device achieves the performance characteristic.

17. The method of claim 16, wherein the imaging-device recalibration criteria includes one or more of a predefined calibration interval, one or more control algorithm predefined thresholds, a request trigger, and underperformance thresholds.

18. The method of claim 16, wherein:
the respective force on the imaging-device element by the actuator causes a change to a position of the imaging-device element; and
the displacement data includes respective position data for the imaging-device element.

19. The method of claim 16, wherein:
the respective force on the imaging-device element by the actuator causes deformation of the imaging-device element; and
the displacement data includes capacitance data for the imaging-device element based on respective deformations of the imaging-device element.

20. The method of claim 16, further comprising:
after calibrating the actuator:
determining object distance range groups based on an object distances for the imaging device, wherein each object distance range group is associated with respective predefined calibration data of the predefined calibration data, and
for each object distance range group of the object distance range groups, determining, based on one or more of an object distance, an image distance, and properties of the imaging-device element, one or more of values for another plurality of drive signals to move the imaging-device element to a predefined position based on the respective predefined calibration data, and
causing the DAC to provide the actuator the other plurality of drive signals including, at least, other drive signals with another predetermined starting value to another predetermined ending value, wherein each of the other drive signals of the other plurality of drive signals causes the actuator to move the imaging-device element to a respective position; and
for each object distance range group:
generating respective recalibration data, distinct from the respective predefined calibration data, based, in part, on the respective displacement data, and
associating the actuator with the respective recalibration data such that the imaging device achieves the performance characteristic.
